(19) United States
(12) Patent Application Publication
(10) Pub. No.: US 2017/0151897 A1
(43) Pub. Date: Jun. 1, 2017

(54) COVER MATERIAL FOR VEHICLE SEAT SHEET

(71) Applicant: SUMINOE TEXTILE CO., LTD., Osaka-shi, Osaka (JP)

(72) Inventors: Hiroshi NISHIKIDO, Osaka-shi, Osaka (JP); Jiro NISHIMURA, Osaka-shi, Osaka (JP)

(73) Assignee: SUMINOE TEXTILE CO., LTD., Osaka-shi, Osaka (JP)

(21) Appl. No.: 15/312,822

(22) PCT Filed: May 15, 2015
(86) PCT No.: PCT/JP2015/063985

§ 371 Date: Nov. 21, 2016

(30) Foreign Application Priority Data
May 20, 2014 (JP) 2014-104203

(51) Int. Cl. B60N 2/58; D03D 1/00

(52) U.S. Cl. CPC B60N 2/58; D03D 1/00

(57) ABSTRACT

A cover material for a vehicle seat sheet can be fit on a seat with the center position of the ornamental part aligned with a predetermined center position of the seat. The cover material includes a first fabric, a second fabric, and a small-width woven fabric. The small-width woven fabric includes an ornamental part of an approximately rectangular shape, a first seam allowance part of an approximately rectangular shape connected one of widthwise edges of the ornamental part, and a second seam allowance part of an approximately rectangular shape connected to the other of the widthwise edges of the ornamental part. An end part of the first fabric is overlapped on and seamed to the first seam allowance part of the small-width woven fabric. An end part of the second fabric is overlapped on and seamed to the second seam allowance part of the small-width woven fabric.

### TECHNICAL FIELD

The present invention relates to a cover material for a vehicle seat sheet improved in design by providing a small-width woven fabric having an ornamental part at a seamed portion of fabrics.

### BACKGROUND ART

As a cover material for a vehicle seat sheet, a material in which an ornamental small-width woven fabric is provided at a seamed portion of fabrics to impart a design accent is known.

With this structure, in an automobile seat, the ornamental small-width woven fabric is visible from the outside. Therefore, by making the color or pattern of the ornamental part of this small-width woven fabric different from the color or pattern of the surface skin fabric, for example, by employing a black color as the color of the surface skin fabric and a red color as the color of the ornamental part of the small-width woven fabric, a partial decoration (a decoration which becomes an accent) can be imparted to the seat, which in turn can improve the sense of design of the seat.

Conventionally, as the aforementioned small-width woven fabric for a cover material for an automobile seat sheet, a woven fabric formed by cutting a large-width woven fabric obtained by weaving into a small-width was used (see Patent Document 1).

### PRIOR ART

### Patent Document

Patent Document 1: Japanese Unexamined Patent Application Publication No. 2002-339185

### SUMMARY OF THE INVENTION

### Problems to be Solved by the Invention

However, in the case of using a woven fabric formed to have a small-width by cutting a large-width woven fabric produced by weaving as a small-width woven fabric, the cutting position cannot be accurately controlled (cutting position fluctuates). Therefore, in cases where the small-width woven fabric is configured to have a design including a center line arranged at a widthwise center of the small-width woven fabric of an approximately rectangular shape so as to extend along a longitudinal direction of the small-width woven fabric, when the cover material is employed as a seat sheet, there is a problem that the position of the center line often deviates from a predetermined position of the seat sheet. When the position of the center line deviates from a predetermined center position, a feeling of strangeness in design is caused significantly, which in turn remarkably deteriorates the sense of design of the cover material applied to the seat. Further, for example, in the case of a design in which a pattern changes in the widthwise direction of the small-width woven fabric of the approximately rectangular shape, if the position of the center line deviates from a predetermined center position of a seat sheet, when the cover material is applied to the seat sheet, the pattern does not form in an accurate line symmetry in which the predetermined center position is positioned as a center of the line symmetry, and therefore the position shift can be recognized. Thus, in the same manner as mentioned above, a feeling of strangeness in design is caused significantly, which in turn remarkably deteriorates the sense of design of the cover material applied to the seat sheet.

The present invention was made in view of the aforementioned technical background, and aims to provide a cover material for a vehicle seat sheet which is excellent in productivity and capable of being applied to a seat with a center position of an ornamental part aligned with a predetermined center position of a seat with a high degree of accuracy and also imparting an excellent sense of design without causing a feeling of strangeness when applied to a seat.

### Means for Solving the Problems

In order to attain the aforementioned objects, the present invention provides the following means.

[1] A cover material for a vehicle seat sheet including:

a first fabric;

a second fabric; and

a small-width woven fabric,

wherein the small-width woven fabric includes an ornamental part of an approximately rectangular shape, a first seam allowance part of an approximately rectangular shape connected to one of widthwise edges of the ornamental part, and a second seam allowance part of an approximately rectangular shape connected to the other of the widthwise edges of the ornamental part,

wherein the small-width woven fabric is a fabric produced by integral weaving with a weaving machine,

wherein an end part of the first fabric is overlapped on and seamed to the first seam allowance part of the small-width woven fabric, and

wherein an end part of the second fabric is overlapped on and seamed to the second seam allowance part of the small-width woven fabric.

[2] The cover material for a vehicle seat sheet as recited in the aforementioned Item [1], wherein the small-width woven fabric is a woven fabric other than a woven fabric produced by cutting into a small-width.

[3] The cover material for a vehicle seat sheet as recited in the aforementioned Item [1] or [2], wherein a width of the small-width woven fabric is in a range of 15 mm to 100 mm.

[4] The cover material for a vehicle seat sheet as recited in any one of the aforementioned Items [1] to [3],

wherein a first folded back part which is an end portion of the first fabric folded back on a back side of the first fabric is overlapped on an upper surface of the first seam allowance part of the small-width woven fabric, and the first seam allowance part, the first folded back part, and the first fabric are overlapped in this order and seamed by a first sewing thread, so that the first sewing thread is visible from an outside on a surface of a side edge portion of the first fabric on the small-width woven fabric side, and

wherein a second folded back part which is an end portion of the second fabric folded back on aback side of the second fabric is overlapped on an upper surface of the second seam allowance part of the small-width woven fabric, and the second seam allowance part, the second folded back part, and the second fabric are overlapped in this order and seamed by a second sewing thread, so that the second sewing thread is visible from an outside on a surface of a side edge portion of the second fabric on the small-width woven fabric side.

[5] The cover material for a vehicle seat sheet as recited in any one of the aforementioned Items [1] to [3],

wherein a first folded back part which is an end portion of the first fabric folded back on a back side of the first fabric is overlapped on an upper surface of the first seam allowance part of the small-width woven fabric, and the first folded back part and the first seam allowance part are overlapped and seamed by a first sewing thread, and the first fabric is arranged on the seamed first folded back part, so that the first sewing thread is invisible from an outside on a surface of the first fabric, and

wherein a second folded back part which is an end portion of the second fabric folded back on aback side of the second fabric is overlapped on an upper surface of the second seam allowance part of the small-width woven fabric, and the second folded back part and the second seam allowance part are overlapped and seamed by a second sewing thread, and the second fabric is arranged on the seamed second folded back part, so that the second sewing thread is invisible from an outside on a surface of the second fabric.

[6] The cover material for a vehicle seat sheet as recited in any one of the aforementioned Items [1] to [5],

wherein the ornamental part of the small-width woven fabric includes one or a plurality of piping parts including a tubular part extending in a lengthwise direction of the ornamental part and a core part arranged at an inside of the tubular part.

[7] The cover material for a vehicle seat sheet as recited in the aforementioned Item [6],

wherein the small-width woven fabric is an integrally woven fabric including a warp forming at least the first seam allowance part, the second seam allowance part, and the tubular part, a weft forming at least the first seam allowance part, the second seam allowance part and the tubular part, and an insertion thread forming the core part, and the warp, the weft, and the insertion thread are integrally woven by a weaving machine.

[8] The cover material for a vehicle seat sheet as recited in the aforementioned Item [7],

wherein the insertion thread is configured by a thread of 84 decitex to 15,000 decitex.

[9] The cover material for a vehicle seat sheet as recited in the aforementioned Item [7] or [8],

wherein the insertion thread is a polyester stretched multifilament thread.

### Effects of the Invention

According to the invention as recited in the aforementioned Items [1] and [2], in the small-width woven fabric, an ornamental part having a design, etc., is arranged between seam allowance parts positioned at both widthwise ends. Therefore, the ornamental part of the small-width woven fabric is visible from the outside, which can impart a sense of design (design accent, etc.) to the cover material for a seat sheet. Further, the small-width woven fabric is a fabric produced by integral weaving with a weaving machine, not produced by cutting a large-width woven fabric to have a small-width. As a result, the center position of the ornamental part can be arranged at a predetermined center position of a seat sheet with a high degree of accuracy, which can impart an excellent sense of design without causing a feeling of strangeness when applied to the seat sheet. Further, the small-width woven fabric is a fabric produced by integral weaving with a weaving machine, and therefore it is excellent in productivity and no fray is caused at both widthwise ends of the small-width woven fabric.

According to the invention as recited in the aforementioned Item [3], the width of the small-width woven fabric is in a range of 15 mm to 100 mm. When the width is equal to or lager than 15 mm, a sufficient seam strength can be secured, and a sense of design can be sufficiently secured. When the width is equal to or less than 100 mm, an excellent productivity can be maintained (when the width is larger than 100 mm, the moving distance of the weft increases, which deteriorates the productivity accordingly, and thus it is not preferable).

According to the invention as recited in the aforementioned Item [4], the first seam allowance part, the first folded back part, and the first fabric are overlapped in this order and these three layers are seamed, and further the second seam allowance part, the second folded back part, and the second fabric are overlapped in this order and these three layers are seamed. Therefore, the seam strength between the small-width woven fabric and the first fabric can be enhanced, and the seam strength between the small-width woven fabric and the second fabric can be enhanced. Further, the first seam line formed on the surface of the side edge portion of the first fabric on the small-width woven fabric side can be visible from the outside, and the second seam line formed on the surface of the side edge portion of the second fabric on the small-width woven fabric side is visible from the outside. Therefore, for example, by making the color of these first and second seam lines (sewing threads) different from a color of the surface of the first and second fabrics, the sense of design of the cover material for a seat sheet can be improved (the sense of design by a design accent can be improved).

According to the invention as recited in the aforementioned Item [5], the first folded back part which is an end portion of the first fabric folded back on a back side of the first fabric is overlapped on an upper surface of the first seam allowance part of the small-width woven fabric, and the first folded back part and the first seam allowance part are overlapped and seamed by a first sewing thread, and the first fabric is arranged on the seamed first folded back part, and the second folded back part which is an end portion of the second fabric folded back on a back side of the second fabric is overlapped on an upper surface of the second seam allowance part of the small-width woven fabric, and the second folded back part and the second seam allowance part are overlapped and seamed by a second sewing thread, and the second fabric is arranged on the seamed second folded back part. Therefore, the first sewing thread is not visible from the outside on the surface of the first fabric and the second sewing thread is not visible from the outside on the second fabric. Accordingly, when this cover material is applied to a seat sheet, since the sewing threads are invisible from the outside, it is possible to impart more excellent design.

According to the invention as recited in the aforementioned Item [6], the ornamental part of the small-width woven fabric includes one or a plurality of piping parts including a tubular part extending in a lengthwise direction of the ornamental part and a core part arranged at an inside of the tubular part. Therefore, due to the existence of the raised piping part, the sense of design can be further improved.

According to the invention as recited in the aforementioned Item [7], the small-width woven fabric is an integrally woven fabric including a warp forming at least the first seam allowance part, the second seam allowance part, and the tubular part, a weft forming at least the first seam allowance part, the second seam allowance part, and the tubular part, and an insertion thread forming the core part, and the warp, the weft, and the insertion thread are integrally woven by a weaving machine. Therefore, there are merits that the productivity can be improved significantly, and the quality as a small-width woven fabric can be equalized. That is, the first and second seam allowance parts and the tubular part can be formed simultaneously by weaving with a single sewing machine (loom), and the insertion arrangement of the insertion thread (core part) in the tubular part can be performed simultaneously (in parallel) (see FIG. 8), and therefore, the productivity can be improved significantly, and the quality as a small-width woven fabric can also be equalized. Accordingly, in the cover material, the tubular part (piping part) of the small-width woven fabric can be visible in a beautiful state, and is excellent in sense of design.

According to the invention as recited in the aforementioned Item [8], since the insertion thread is configured by a thread of 84 decitex to 15,000 decitex, the exterior design of the piping part (the tubular part in which the insertion thread is arranged) can be improved, and even when seated in a state of being in contact with the piping part, it is possible to sufficiently improve the seating comfort when seated without causing uncomfortableness (stiffness, etc.). Therefore, it is sufficiently possible to arrange the small-width woven fabric of the cover material at a portion (position) which comes into contact with a human body when seated.

According to the invention as recited in the aforementioned Item [9], since the insertion thread is a polyester stretched multifilament thread, the elasticity of the core part can be improved. Even when seated in a state of being in contact with the tubular part (piping part) of the small-width woven fabric of the cover material, a user does not feel uncomfortable (stiffness, etc.), which makes it possible to further improve the seating comfort. Therefore, it is sufficiently possible to arrange the small-width woven fabric of the cover material at a portion (position) which comes into contact with a human body when seated.

### BRIEF DESCRIPTION OF THE DRAWINGS

FIG. 1 is a perspective view showing an automobile seat sheet configured using a cover material for a vehicle seat sheet according to the present invention.

FIG. 2 is a perspective view showing a small-width woven fabric.

FIG. 3 is a perspective view showing the steps of seaming a first fabric and a second fabric to a small-width woven fabric.

FIG. 3A illustrates a state before the first and second fabrics are overlapped on the small-width woven fabric. FIG. 3B illustrates a state in which the first folded back part which is an end portion of the first fabric is overlapped on the first seam allowance part of the small-width woven fabric and the second folded back part which is an end portion of the second fabric is overlapped on the second seam allowance part of the small-width woven fabric. FIG. 3C illustrates a use state in which the first seam allowance part, the first folded back part, and the first fabric are seamed, and the second allowance part, the second folded back part, and the second fabric are seamed, so that the sewing threads (stitching yarn) are invisible from the outside.

FIG. 4 is a cross-sectional view taken along the line X-X in FIG. 1.

FIG. 5 is a perspective view showing production steps of a cover material for a vehicle seat sheet according to another embodiment of the present invention. FIG. 5A illustrates a state before the first and second fabrics are overlapped on the small-width woven fabric. FIG. 5B illustrates a state in which the first folded back part which is an end portion of the first fabric is overlapped on and seamed to the first seam allowance part of the small-width woven fabric and the second folded back part which is an end portion of the second fabric is overlapped on and seamed to the second seam allowance part of the small-width woven fabric. FIG. 5C illustrates a use state in which the first fabric is arranged on the sewing thread of the first folded part and the second fabric is arranged on the sewing thread of the second folded back part, and these sewing threads are invisible from an outside.

FIG. 6 is a cross-sectional view of an automobile seat sheet configured using the cover material for a seat sheet shown in FIG. 5.

FIG. 7 is a perspective view showing another example of a small-width woven fabric.

FIG. 8 is a schematic explanatory view showing one example of a weaving method of the small-width woven fabric shown in FIG. 7 and a perspective view showing a state in which the small-width woven fabric is being weaved.

FIG. 9 is a plan view of a first test piece used in a Taber scratch test.

FIG. 10 is a plan view showing a test piece used in a mace snagging test, wherein FIG. 10A is a plan view of a first test piece, and FIG. 10B is a plan view of a second test piece.

FIG. 11 is a plan view showing a test piece used in a hook-and-loop fastener type scratch test, wherein FIG. 11A is a plan view of a first test piece, and FIG. 10B is a plan view of a second test piece.

FIG. 12 is a plan view showing a test piece used in a friction durability test, wherein FIG. 12A is a plan view of a first test piece, and FIG. 11B is a plan view of a second test piece.

### EMBODIMENTS FOR CARRYING OUT THE INVENTION

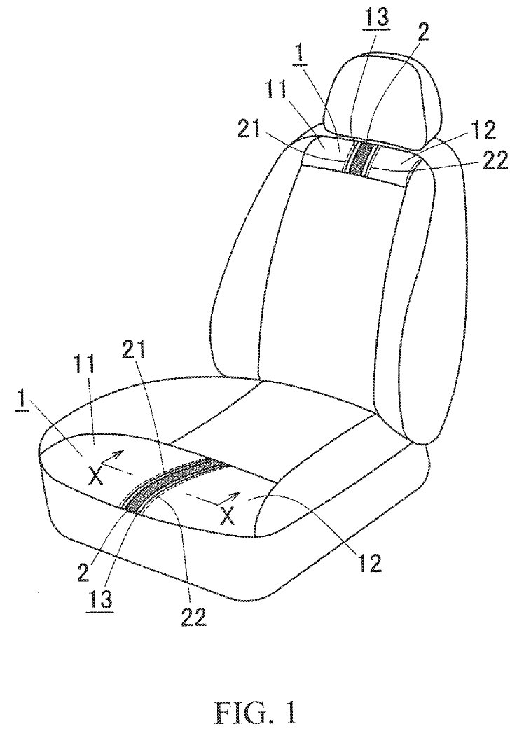

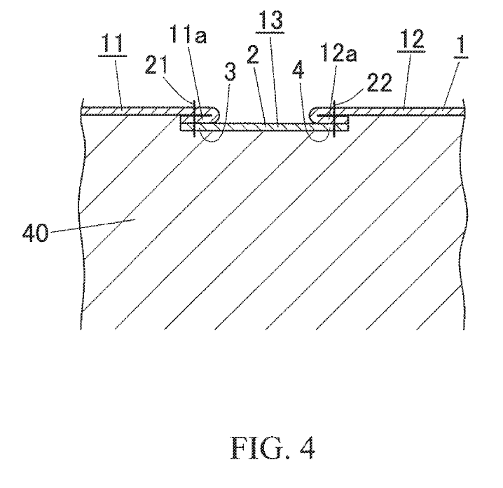

A state in which a cover material 1 for a vehicle seat sheet according to one embodiment of the present invention is applied to a vehicle seat sheet is shown in FIG. 1. A partial cross-sectional view in this applied state is shown in FIG. 4.

The cover material 1 for a vehicle seat sheet according to the present invention is equipped with at least a first fabric 11, a second fabric 12, and a small-width woven fabric 13 (see, FIGS. 1, 3, and 4).

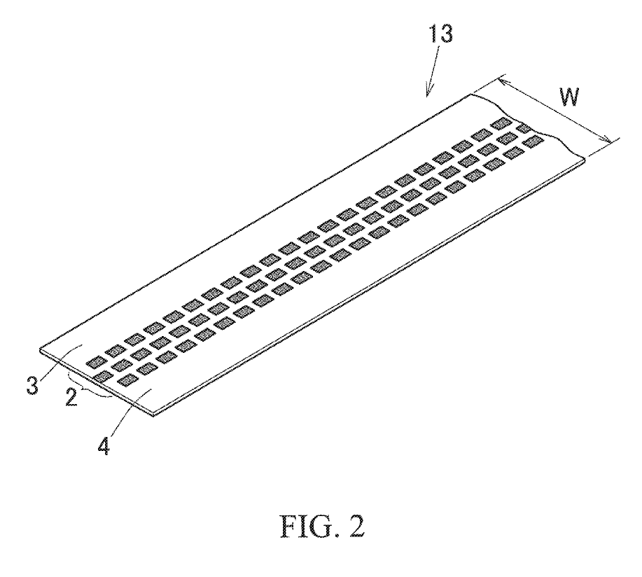

The small-width woven fabric 13 has an approximately rectangular shape, and, as shown in FIG. 2, is configured to include an ornamental part 2 which is an approximately rectangular shape, a first seam allowance part 3 of an approximately rectangular shape connected one of widthwise edges of the ornamental part 2, and a second seam allowance part 4 of an approximately rectangular shape connected to the other of the widthwise edges of the ornamental part 2.

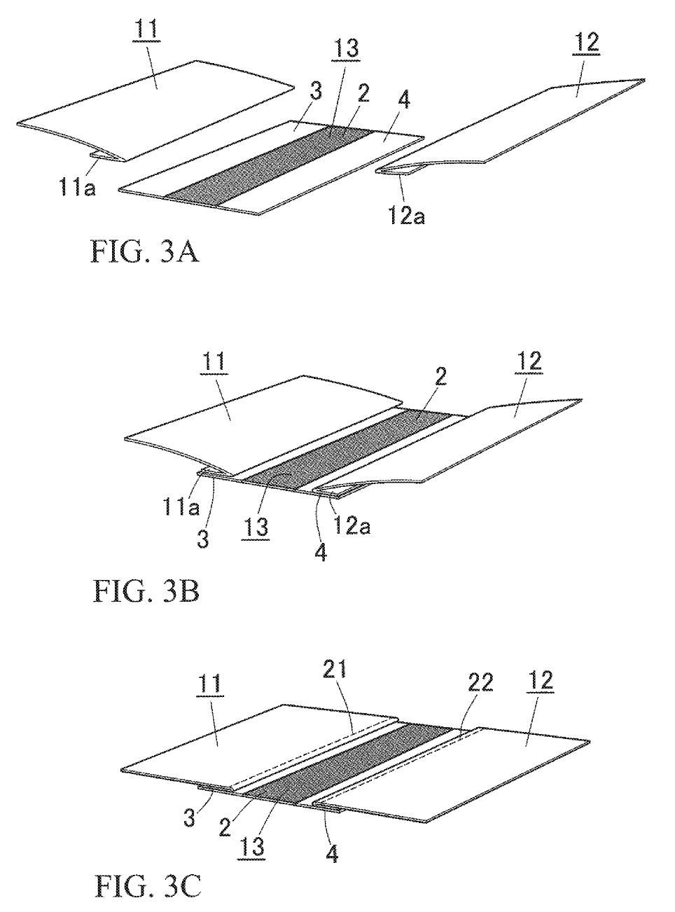

In this embodiment, the design of the ornamental part 2 has a configuration in which a number of rectangular shaped different color portions (different color portions different in color from the first and second allowance parts) as shown in FIG. 2. In FIGS. 1 and 3, however, for the sake of simplifying the drawing, the entirety of the ornamental part 2 is illustrated as a gray color. It should be noted that the design of the ornamental part 2 is not specifically limited to the design shown in FIG. 2, and any design may be employed. For example, the design of the ornamental part 2 may be a mere single color base (for example, a red base) with no pattern or a multi-color base with a pattern. Further, in the ornamental part 2, for example, there may exist one or a plurality of areas not having a design in the longitudinal direction of the ornamental part. Although a number of such design-non-existing areas (areas other than rectangular shaped different color portions in the ornamental part 2 in FIG. 2) are provided in FIG. 2, one or a plurality of design-non-existing areas longer in the longitudinal direction than that shown in FIG. 2 may be provided. Alternatively, it may be configured such that most of the area of the longitudinal intermediate portion is a design-non-existing area and designs (different color portion, etc.) exist only on both longitudinal end portions.

The small-width woven fabric 13 is a fabric produced by integral weaving with a single weaving machine (loom). That is, the first seam allowance part 3, the second seam allowance part 4, and the ornamental part 2 are integrally woven with warps and wefts.

Thus, the first folded back part 11a (see FIG. 3A) which is one end portion of the first fabric 11 folded back on aback side of the first fabric 11 is overlapped on an upper surface of the first seam allowance part 3 of the small-width woven fabric 13, and the first seam allowance part 3, the first folded back part 11a, and the first fabric (excluding the first folded back part) 11 are overlapped in this order (see FIG. 3B) and these three layers are seamed by a first sewing thread 21, so that a first seam line 21 is formed on the surface of the side edge portion of the first fabric 11 on the small-width woven fabric 13 side and the first seam line 21 is visible from the outside (see FIG. 3C and FIG. 4).

Further, the second folded back part 12a (see FIG. 3A) which is one end portion of the second fabric 12 folded back on a back side of the second fabric 12 is overlapped on an upper surface of the second seam allowance part 4 of the small-width woven fabric 13, and the second seam allowance part 4, the second folded back part 12a, and the second fabric (excluding the second folded back part) 12 are overlapped in this order (see FIG. 3B) and these three layers are seamed by a second sewing thread 22, so that a second seam line 22 is formed on the surface of the side edge portion of the second fabric 12 on the small-width woven fabric 13 side and the second seam line 22 is visible from the outside (see FIG. 3C and FIG. 4).

In the cover material 1 for a vehicle seat sheet according to the aforementioned configuration, since the ornamental part 2 having a design, etc., is arranged between the widthwise both end seam allowance parts 3 and 4 in the small-width woven fabric 13, a sense of design (accent of design, etc.) can be imparted to the cover material 1 for a seat sheet. Further, the small-width woven fabric 13 is a fabric produced by integral weaving with a weaving machine, not produced by cutting a large-width woven fabric to have a small-width. Therefore, the center position of the ornamental part 2 can be arranged at a predetermined center position of a seat with a high degree of accuracy, which can impart an excellent sense of design without causing a feeling of strangeness when applied to the seat sheet. Further, since the small-width woven fabric 13 is a fabric produced by integral weaving with a weaving machine, the small-width woven fabric 13 is excellent in productivity and high in quality since no fray occurs at both widthwise ends of the small-width woven fabric 13 (no fray will occur since it is not produced by cutting).

Further, the first seam allowance part 3, the first folded back part 11a, and the first fabric 11 (excluding the first folded back part) are overlapped in this order and these three layers are seamed, and further the second seam allowance part 4, the second folded back part 12a, and the second fabric 12 (excluding the second folded back part) are overlapped in this order and these three layers are seamed. Therefore, the seam strength between the small-width woven fabric 13 and the first fabric 11 can be enhanced, and the seam strength between the small-width woven fabric 13 and the second fabric 12 can be enhanced.

In addition, the first sewing thread (first seam line) 21 formed on the surface of the side edge portion of the first fabric 11 on the small-width woven fabric 13 side is visible from the outside, and the second sewing thread (second seam line) 22 formed on the surface of the side edge portion of the second fabric 12 on the small-width woven fabric 13 side is also visible from the outside. For example, by making the color of these first and second sewing threads (seam lines) different from the color of the surface of the first and second fabrics, the sense of design of the cover material 1 for a seat sheet can be improved (by imparting an accent of a design due to the visibility of the first and second sewing threads different from the color of the surface of the first and second fabrics, the sense of design by a design accent can be improved).

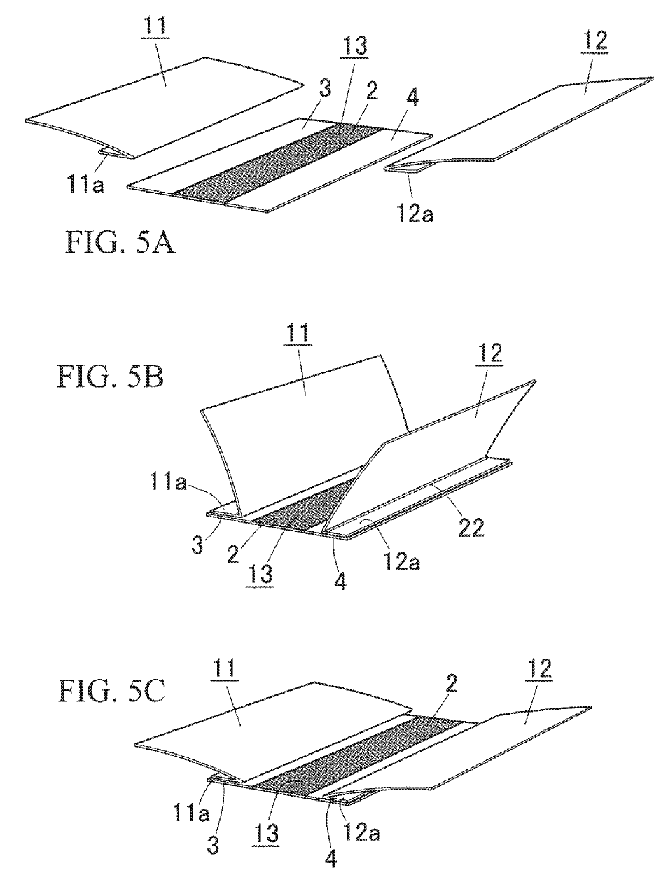

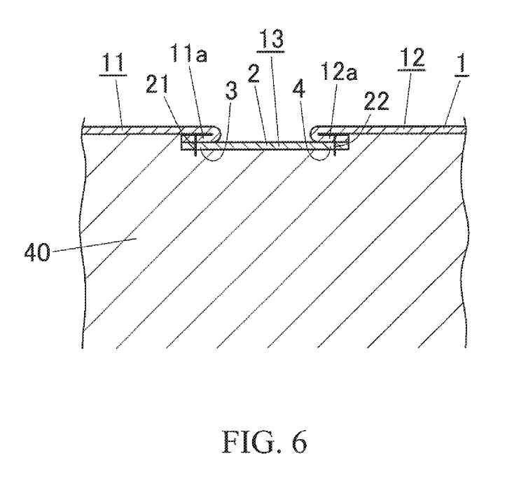

Next, another embodiment of a cover material 1 for a vehicle seat sheet according to the present invention will be described. In this embodiment, the first folded back part 11a (see FIG. 5A) which is one end portion of the first fabric 11 folded back on a back side of the first fabric 11 is overlapped on an upper surface of the first seam allowance part 3 of the small-width woven fabric 13. In this overlapped state, the first folded back part 11a and the first seam allowance part 3 of the small-width woven fabric 13 are seamed by the first sewing thread 21 (see FIG. 5B and FIG. 6). On this seamed first folded back part 11a, the first fabric (excluding the first folded back part) 11 is arranged, so that the first sewing thread (first seam line) 21 on the surface (upper surface) of the first folded back part 11a is invisible from the outside (FIG. 5C and FIG. 6).

Further, the second folded back part 12a (see FIG. 5A) which is one end portion of the second fabric 12 folded back on a back side of the second fabric 12 is overlapped on an upper surface of the second seam allowance part 4 of the small-width woven fabric 13. In this overlapped state, the second folded back part 12a and the second seam allowance part 4 of the small-width woven fabric 13 are seamed by the second sewing thread 22 (see FIG. 5B and FIG. 6). On this seamed second folded back part 12a, the second fabric (excluding the first folded back part) 12 is arranged, so that the second sewing thread (second seam line) 22 on the surface (upper surface) of the second folded back part 12a is invisible from the outside (FIG. 5C and FIG. 6).

In the cover material 1 for a vehicle seat sheet according to the aforementioned configuration, since the ornamental part 2 having a design, etc., is arranged between the widthwise both end seam allowance parts 3 and 4 in the small-width woven fabric 13, a sense of design (accent of design, etc.) can be imparted to the cover material 1 for a seat sheet. Further, the small-width woven fabric 13 is a fabric produced by integral weaving with a weaving machine, not produced by cutting a large-width woven fabric to have a small-width. Therefore, the center position of the ornamental part 2 can be arranged at a predetermined center position of a seat with a high degree of accuracy, which can impart an excellent sense of design without causing a feeling of strangeness when applied to the seat sheet. Further, since the small-width woven fabric 13 is a fabric produced by integral weaving with a weaving machine, the small-width woven fabric 13 is excellent in productivity and high in quality since no fray occurs at both widthwise ends of the small-width woven fabric 13 (no fray will occur since it is not produced by cutting).

Thus, the cover material 1 for a seat sheet is provided (arranged) in a state of covering the surface of the seat cushion body 40 (see FIGS. 4 and 6). Thus, a seat sheet for a vehicle is configured (See FIG. 1).

In the automobile cover material 1 for a seat sheet applied, the upper surface of the ornamental part 2 is visible from the outside (see FIGS. 1, 4, and 6). In this embodiment, since the ornamental part 2 is visible from the outside in a linear state (in a line state) as shown in FIG. 1 as a whole, for example, by designing such that the ornamental part 2 is different in color from the first and second fabrics 11 and 12, this visible ornamental part 2 becomes an accent of design, which can impart an excellent sense of design.

In the aforementioned embodiment, although a configuration is employed in which the first folded back part 11a is formed in the first fabric 11, and this first folded back part 11a is seamed to the first seam allowance part 3 (see FIG. 3 and FIG. 5), but it is not specifically limited to such a configuration. For example, a structure may be employed in which an end portion (an end portion in a non-folded state) of the first fabric 11 is overlapped on and seamed to the first seam allowance part 3 of the small-width woven fabric 13.

In the same manner, in the aforementioned embodiment, although a configuration is employed in which the second folded back part 12a is formed in the second fabric 12, and this second folded back part 12a is seamed to the second seam allowance part 4 (see FIG. 3 and FIG. 5), but it is not specifically limited to such a configuration. For example, a structure may be employed in which an end portion (an end portion in a non-folded state) of the second fabric 12 is overlapped on and seamed to the second seam allowance part 4 of the small-width woven fabric 13.

In this embodiment, although the first fabric 11 is a fabric configuring a left side material among the cover material 1, and the second fabric 12 is a fabric configuring a right side material among the cover material 1, it is not specifically limited to such a configuration.

In the aforementioned embodiment, although the cover material 1 of the present invention is applied to the upper portion of the back support portion and the front portion of the seat portion (portion with which a thigh comes into contact) of the seat sheet, the application portion is not specifically limited to the aforementioned portions.

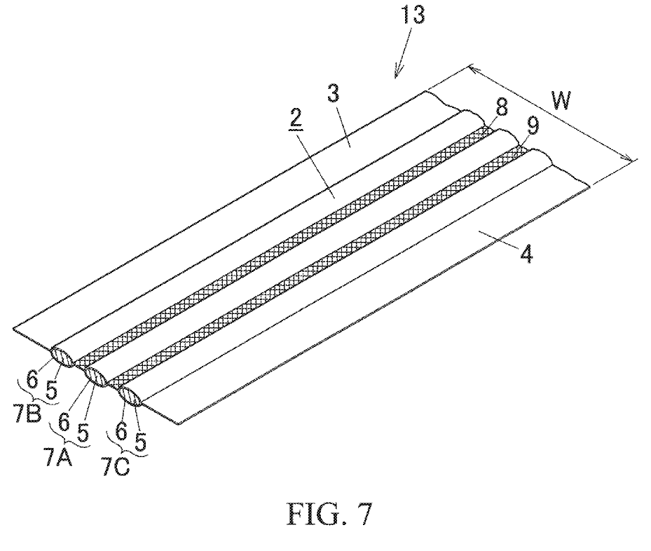

Next, another embodiment of a small-width woven fabric 13 configuring a cover material 1 for a vehicle seat sheet according to the present invention is shown in FIG. 7.

The small-width woven fabric 13 has an approximately rectangular shape, and, as shown in FIG. 7, is configured to include an ornamental part 2 which is an approximately rectangular shape, a first seam allowance part 3 of an approximately rectangular shape connected to one of widthwise edges of the ornamental part 2, and a second seam allowance part 4 of an approximately rectangular shape connected to the other of the widthwise edges of the ornamental part 2.

The ornamental part 2 of the small-width woven fabric 13 includes one or a plurality of piping parts 7 each including a tubular part 6 extending in a lengthwise direction of the ornamental part 2 and a core part 5 (33) arranged at an inside of the tubular part 6 in an inserted manner.

In this embodiment, the ornamental part 2 is provided with a piping part 7A arranged at a widthwise center portion, a first flat fabric part 8 connected to one widthwise side (left side) of the tubular part 6 configuring the piping part 7A, a piping part 7B connected to the outer widthwise side (left side) of the first flat fabric part 8, a second flat fabric part 9 connected to the other widthwise side (right side) of the tubular part 6 configuring the piping part 7A, and a piping part 7C connected to the widthwise outer side (right side) of the second flat fabric part 9. The first seam allowance part 3 is connected to the widthwise outer side (left side) of the piping part 7B, and the second seam allowance part 4 is connected to the widthwise outer side (right side) of the piping part 7C. A part (upper part) of the piping part 7 (tubular part 6) is higher than (i.e., protruded from) the surface position of the first seam allowance part 3 and the second seam allowance part 4.

The small-width woven fabric 13 (the small-width woven fabric shown in FIG. 7) is a fabric produced by integral weaving with a single weaving machine (loom).

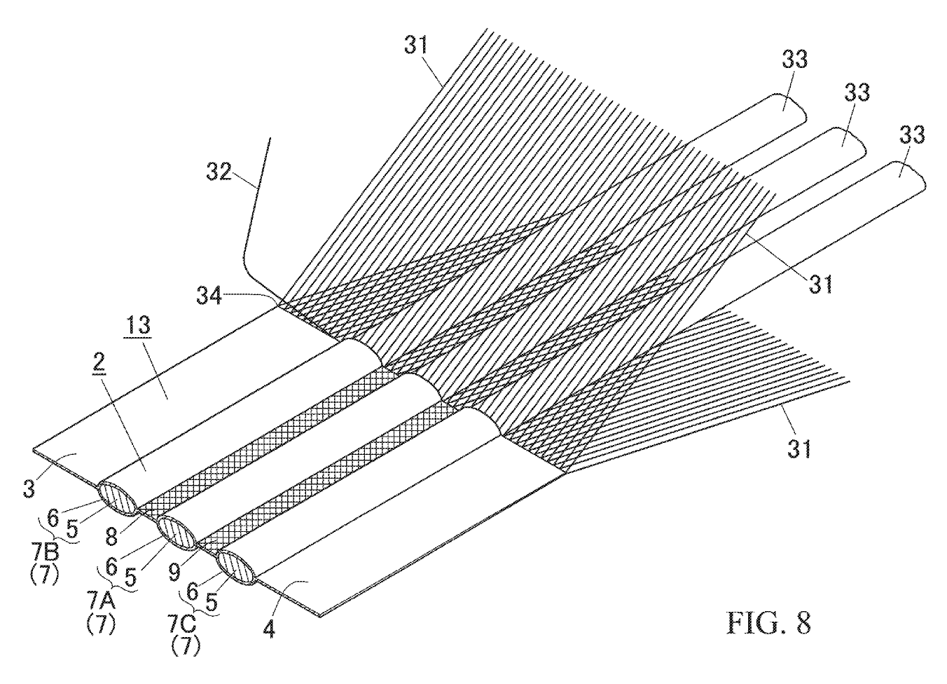

An example of a weaving method of the small-width woven fabric 13 is shown in FIG. 8. As shown in FIG. 8, a number of warps 31 are supplied toward a weaving position 34 from an obliquely upper side, and a number of warps 31 are supplied toward the weaving position 34 from an obliquely lower side. Further, insertion threads 33 are also supplied from a rear side (thread supplying side) between a group of the warps 31 supplied from the obliquely upper side and a group of the warps 31 supplied from the obliquely lower side. At the weaving position 34, the first seam allowance part 3, the second seam allowance part 4, the first flat fabric part 8, the second flat fabric part 9, and the tubular parts 6, 6, and 6 are weaved with the warps 31 supplied from the obliquely upper side, the warps 31 supplied from the obliquely lower side, and a weft 32. At the same time, the insertion thread 33 is made to be arranged in an inner space of the tubular part 6 in an inserted manner. Thus, the small-width woven fabric 13 shown in FIG. 7 is obtained. This small-width woven fabric 13 is produced by the aforementioned weaving method, and therefore, is a non-cut product and a non-seamed product in which no adhesive is used (applied). That is, the aforementioned small-width woven fabric 13 is a product produced by the aforementioned weaving method, and therefore, no cutting step is required, no seaming step is required, and no adhesion by an adhesive is required. Thus, it is extremely excellent in productivity. Further, the small-width woven fabric 13 is a product obtained by weaving, the quality is equalized.

In the present invention, the width W of the small-width woven fabric 13 is preferably set to 15 mm to 100 mm (see FIGS. 2 and 7). When the width is 15 mm or more, it is possible to secure a sufficient seam strength and a sufficient sense of design. Further, when the width is 100 mm or less, it is possible to maintain an excellent productivity. Among other things, the width W of the small-width woven fabric 13 is preferably set to 20 mm to 50 mm, especially 33 mm to 35 mm.

As the warp configuring the small-width woven fabric 13, it is preferable to use a thread of 33 decitex to 1,000 decitex. In this case, it is possible to increase the strength of the ornamental part 2, the first seam allowance part 3, and the second seam allowance part 4.

As the warp, it is preferable to use a twisted thread with the number of twists of 100 to 350. Further, the interlace condition of the warp is preferably within a range of 50 piece/m to 150 piece/m.

As the weft, it is preferable to use a thread of 33 decitex to 1,000 decitex. In this case, it is possible to increase the strength of the ornamental part 2, the first seam allowance part 3, and the second seam allowance part 4.

As the structural form of the seam allowance part 3 and 4, although not specifically limited, for example, a plain woven structure, a twill woven structure, a satin woven structure, etc., can be exemplified. Among other things, the structural form of the seam allowance part 3 and 4 is preferably a plain woven structure.

Further, in the case of employing a configuration in which the flat fabric parts 8 and 9 are provided, as the structural form of the flat fabric part 8 and 9, although not specifically limited, for example, a plain woven structure, a twill woven structure, a satin woven structure, etc., can be exemplified.

As the insertion thread 33, for example, a resin thread, such as, e.g., a polyester stretched multifilament thread, a vinyl chloride thread, and a polyethylene thread, can be exemplified. Among other things, as the insertion thread 33, it is preferable to use a polyester stretched multifilament thread. In this case, even when seated in a state of being in contact with the piping part 7, it is possible to sufficiently improve the seating comfort without causing uncomfortableness (stiffness, etc.).

As the insertion thread 33, it is preferable to use a thread of 84 decitex to 15,000 decitex. By using a thread of 84 decitex (dtex) or more, it is possible to sufficiently secure the design effect by the piping part 7, and by using a thread of 15,000 decitex (dtex) or less, it is possible to sufficiently improve the seating comfort when seated without causing uncomfortableness (stiffness, etc.) even when seated in a state of being in contact with the piping part 7. Among other things, as the insertion thread 33, it is especially preferable to use a thread of 2,000 decitex to 10,000 decitex.

As the structural form of the tubular part 6, although not specifically limited, for example, a hollow woven structure (structure in which warps are woven into a bag-shape in a dispersed manner up and down on the front and back) can be exemplified.

As the first fabric 11 and the second fabric 12, although not specifically limited, for example, a dobby fabric (a polyester fiber dobby fabric, etc.), a jacquard fabric (a polyester fiber jacquard fabric, etc.), a tricot (a polyester fibers tricot, etc.), a circular knitted fabric (a polyester fiber round knitted fabric, etc.), and a Russell fabric (a polyester fiber Russell cloth, etc.) can be exemplified.

As the sewing thread 21 and 22 used for seaming, although not specifically limited, for example, a polyester spun yarn, etc., can be exemplified. The thickness of the sewing thread 21 and 22 is preferably a 4^{th} to 12^{th}.

### EXAMPLE

Next, specific examples of the present invention will be described. It should be noted, however, that the present invention is not especially limited to these examples.

### Example 1

A small-width woven fabric 13 shown in FIG. 2 was obtained by weaving under the following designing and conditions.

Weaving machine (Loom): narrow width needle weaving machine

Warp density: 321 pieces/2.54 cm

Weft density: 157 pieces/2.54 cm

Warp: 238 pieces of polyester multifilament threads of 167 decitex (twisted thread: the number of twists was 300) and 4 pieces of polyester monofilament threads of 330 decitex

Weft: polyester multifilament thread of 110 decitex

Structure of ornamental part: satin woven structure

Structure of first and second seam allowance parts: satin woven structure

Width W of the small-width woven fabric: 34 mm

Next, as shown in FIG. 5, the first folded back part 11a which was an end portion of the first fabric 11 made of a polyester fiber dobby woven fabric was overlapped on the upper surface of the first seam allowance part 3 of the small-width woven fabric 13 and the second folded back part 12a which was an end portion of the second fabric 12 made of a polyester fiber dobby woven fabric was overlapped on the upper surface of the second seam allowance part 4 of the small-width woven fabric 13. In this state, the first folded back part 11a and the first seam allowance part 3 of the small-width woven fabric were seamed with a polyester spun yarn (first sewing thread) 21, and the second folded back part 12a and the second seam allowance part 4 of the small-width woven fabric were seamed with a polyester spun yarn (second sewing thread) 22. Thus, a cover material 1 for an automobile seat sheet shown in FIG. 5C was obtained. In a state in which the obtained cover material 1 for an automobile seat sheet was applied to a seat, the ornamental part 2 of the small-width woven fabric 13 was visible from the outside, and the seam lines 21 and 22 by the sewing threads were invisible from the outside (see FIGS. 5C and 6).

### Example 2

A small-width woven fabric 13 shown in FIG. 7 was obtained by weaving with a weaving method shown in FIG. 8 under the following design, conditions, etc.

Weaving machine (Loom): narrow width needle weaving machine

Warp density: 408 pieces/2.54 cm

Weft density: 180 pieces/2.54 cm

Warp: 352 pieces of polyester multifilament threads of 167 decitex (twisted thread: the number of twists was 250) and 8 pieces of polyester films (80 cuts) (the polyester films were arranged only on the first and second flat fabrics)

Weft: polyester multifilament thread of 110 decitex

Insertion thread: 330 pieces of polyester multifilament threads of 330 decitex

Structure of first and second seam allowance parts: plain weave structure

Structure of first and second flat fabric parts: satin woven structure

Structure of tubular part: satin woven structure

Width W of the small-width woven fabric: 50 mm

Next, as shown in FIG. 5, the first folded back part 11a which was an end portion of the first fabric 11 made of a polyester fiber dobby woven fabric was overlapped on the upper surface of the first seam allowance part 3 of the small-width woven fabric 13 and the second folded back part 12a which was an end portion of the second fabric 12 made of a polyester fiber dobby woven fabric was overlapped on the upper surface of the second seam allowance part 4 of the small-width woven fabric 13. In this state, the first folded back part 11a and the first seam allowance part 3 of the small-width woven fabric were seamed with a polyester spun yarn (first sewing thread), and the second folded back part 12a and the second seam allowance part 4 of the small-width woven fabric were seamed with a polyester spun yarn (second sewing thread). Thus, a cover material for an automobile seat sheet was obtained. In a state in which the obtained cover material for an automobile seat sheet was applied to a seat, the ornamental part of the small-width woven fabric was visible from the outside and the seam line by the sewing thread was invisible from the outside.

For each cover material for an automobile seat sheet obtained as described above, evaluations were performed based on the following evaluation method. These results are shown in Table 1.

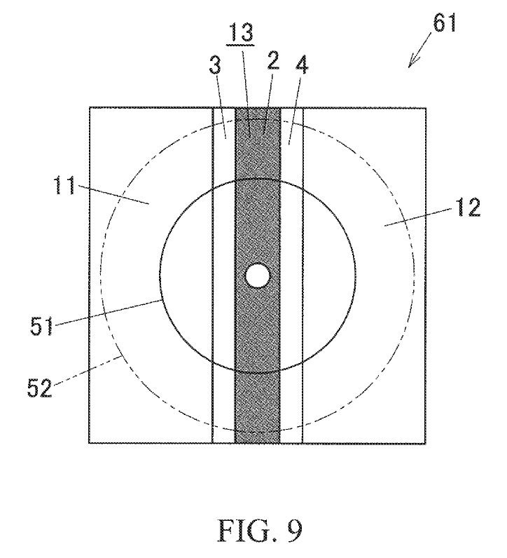

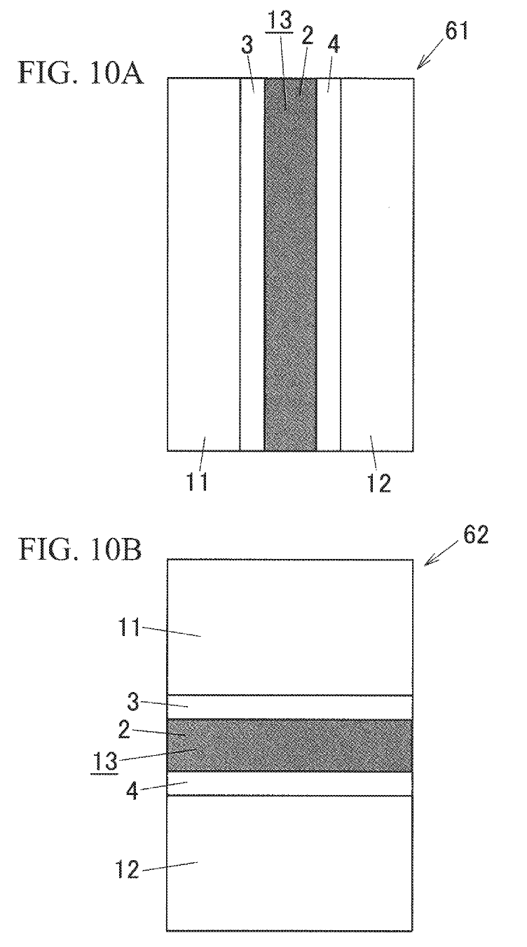

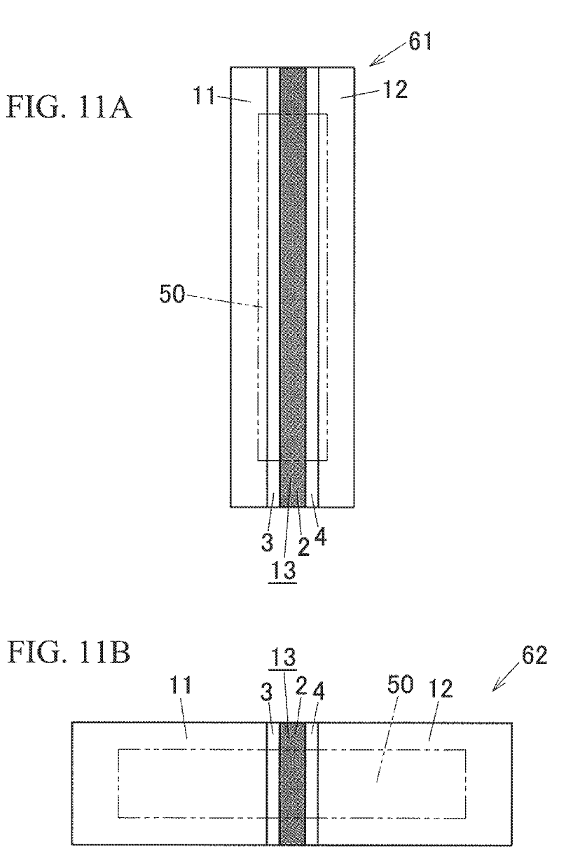

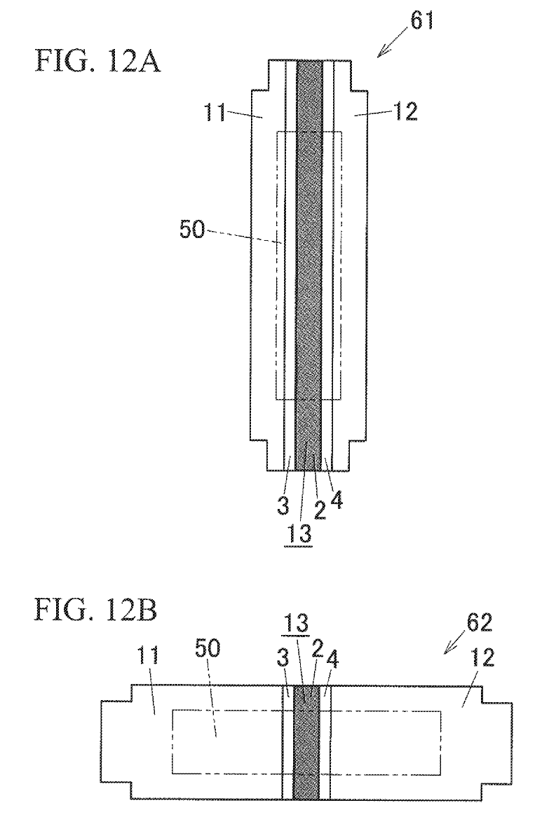

TABLE 1

| | | Example 1 | Example 2 |
|---|---|---|---|
| Taber scratch | First test piece | Level 4 | Level 3 |
| test | (FIG. 9) | | |
| Mace snagging | First test piece | Level 4 | Level 3 |
| test | (FIG. 10A) | | |
| | Second test | Level 4 | Level 3 |
| | piece (FIG. 10B) | | |
| Hook-and-loop | First test piece | Level 4 | Level 3 |
| fastener type | (FIG. 11A) | | |
| scratch test | Second test | Level 4 | Level 3 |
| | piece (FIG. 11B) | | |
| Friction | First test piece | Level 4 | Level 4 |
| durability test | (FIG. 12A) | | |
| | Second test | Level 4 | Level 4 |
| | piece (FIG. 12B) | | |

### <Surface Durability Evaluation Method of Cover Material>

### (Taber Scratch Test)

A first test piece 61 having the shape and the size shown in FIG. 9 was obtained by cutting the obtained cover material for an automobile seat sheet. Further, it was cut along a circular cutting line (two-dot chain line) 52 into a circular shape. Next, a needle was attached to a Taber scratch test machine, and in a state in which the needle tip of the needle (the tip end of the needle) was in contact with the surface of the first test piece 61 and a load of 200 g was applied, the test piece was rotated twice at a rotation speed of 1 rpm. The circular solid line 51 in FIG. 9 shows a contact orbit of the needle tip. After the test, the nature of the surface of the first test piece was observed visually, and evaluated based on the following judgement criteria. It was evaluated such that Level 3, Level 4, and Level 5 were passed.

### (Judgement Criteria)

Level 5—no damage was observed at all

Level 4—although some damages due to the scratching, but no protrusion of thread

Level 3—although there were protrusions of threads, they were hard to be noticeable.

Level 2—there were protrusions of threads, which were remarkably noticeable. Some threads were cut, which were noticeable.

Level 1—protrusions of threads were remarkably noticeable. The fibers were cut and broken.

### (Mace Snagging Test)

Two first test pieces 61 each having the shape and the size shown in FIG. 10A and two second test pieces 62 each having the shape and the size shown in FIG. 10B were obtained by cutting the obtained cover material for an automobile seat sheet. Two first test pieces were sewed with the surfaces (designed surface of the ornamental part 2) facing inward to obtain a cylindrical member (in a manner such that the lines of the ornamental part 2 were parallel to the center axis of the cylindrical member), and then the cylindrical member was reversed. Thus, a cylindrical first test piece in which the surfaces of the first test pieces (designed surface of the ornamental part 2) were exposed outward was obtained. In the same manner, two second test pieces were sewed with the surfaces (designed surface of the ornamental part 2) facing inward to obtain a cylindrical member (in a manner such that the lines of the ornamental part 2 were circular along the outer peripheral surface of the cylindrical member), and then the cylindrical member was reversed. Thus, a cylindrical second test piece in which the surfaces of the second test pieces (designed surface of the ornamental part 2) were exposed outward was obtained. Using an ICI type Mace testing machine defined by JIS L1058-2005, each cylindrical test piece was mounted on the outer surface of a rotary shaft body of the Mace testing machine. The rotary shaft body was rotated 100 times at a rotary rate of 60 rpm. Thus, a snagging test was executed against the outer peripheral surface (designed surface of the ornamental part 2) of the cylindrical test piece. After the test, the nature of the surface of each test piece was observed visually, and evaluated based on the following judgement criteria. It was evaluated such that Level 3, Level 4, and Level 5 were passed.

### (Judgement Criteria)

Level 5—no generation of snag (protrusion of threads) was recognized at all.

Level 4—although there were some damages due to the snagging (protrusion of threads), but the number was extremely small.

Level 3—although there were protrusions of threads, but they were hard to be noticeable. Although some threads were cut, they were hard to be noticeable.

Level 2—there were protrusions of threads, and the number was large. Some threads were cut, they were noticeable.

Level 1—protrusions of threads were remarkably noticeable, and the number thereof was large. The fibers were cut and broken.

### (Hook-and-Loop Fastener Type Scratch Test)

A first test piece 61 having the shape and the size shown in FIG. 11A and a second test piece 62 having the shape and the size shown in FIG. 11B were obtained by cutting the obtained cover material for an automobile seat sheet. Using a friction testing machine I type defined by JIS L0849-2004, as a friction piece, a friction piece rolled up with a hook-and-loop faster in which the friction surface faces the front surface (with hooks) was used. And, the friction piece was reciprocated 10 times between points of 150 mm under a load of 8.0 N at the rate of 60 times per minute. The region surrounded by the two-dot chain line in FIGS. 11A and 11B was a reciprocate region 50 of the friction piece. After the 10 reciprocations, the degree of fluffing on the surface of each test piece was observed visually, and evaluated based on the following judgement criteria. It was evaluated such that Level 3, Level 4, and Level 5 were passed.

### (Judgement Criteria)

Level 5—no fluffing was observed at all Level 4—although there were some fluffing, but there was no fiber cut

Level 3—although there were some fluffing, there was hard to be noticeable, and there was fiber cuts, which were hard to be noticeable

Level 2—there were noticeable fluffing, and fibers were cut, which was noticeable

Level 1—there were extremely noticeable fluffing, and fibers were cut, which was noticeable, or broken.

### (Friction Durability Test)

A first test piece 61 having the shape and the size shown in FIG. 12A and a second test piece 62 having the shape and the size shown in FIG. 12B were obtained by cutting the obtained cover material for an automobile seat sheet. Using a friction testing machine II type defined by JIS L0849-2004, a cotton canvas No. 10 was used as a friction piece, and was reciprocated 3,000 times under a load of 5 N between points of 100 mm at a reciprocate rate of 30 times per minute. The region surrounded by the two-dot chain line in FIGS. 12A and 12B was a reciprocate region 50 of the friction piece. After the 3,000 reciprocations, the degree of abrasion and the appearance change on the surface of each test piece was observed visually, and the friction durability was evaluated based on the following judgement criteria. It was evaluated such that Level 3, Level 4, and Level 5 were passed.

### (Judgement Criteria)

Level 5—no abrasion and no appearance change was observed

Level 4—slight abrasion and appearance change were observed

Level 3—some abrasion and appearance change were observed, but it was a level causing no practical problem

Level 2—abrasion and appearance change were very noticeable

Level 1—abrasion and appearance change were extremely noticeable

As will be apparent from Table 1, for the cover materials for an automobile seat sheet according to Examples 1 and 2 of the present invention, the aforementioned all four evaluations were passed, and the surface durability was excellent.

### INDUSTRIAL APPLICABILITY

The cover material 1 for a vehicle seat sheet according to the present invention can be preferably used as a cover material for an automobile seat sheet, but not limited to such application.

The present application claims priority to Japanese Patent Application No. 2014-104203 filed on May 20, 2014, the entire disclosure of which is incorporated herein by reference in its entirety.

It should be understood that the terms and expressions used herein are used for explanation and have no intention to be used to construe in a limited manner, and allow various modifications falling within the claimed scope of the present invention.

### DESCRIPTION OF REFERENCE SYMBOLS

1 cover material for a vehicle seat sheet
2 ornamental part
3 first seam allowance part
4 second seam allowance part
5 core part (insertion thread)
6 tubular part
7 piping part
11 first fabric
11a first folded back part
12 second fabric
12a second folded back part
13 small-width woven fabric
21 first sewing thread (first seam line)
22 second sewing thread (second seam line)
31 warp
32 weft
33 insertion thread
W width of the small-width woven fabric

1. A cover material for a vehicle seat sheet comprising:
a first fabric;
a second fabric; and
a small-width woven fabric,
wherein the small-width woven fabric includes an ornamental part of an approximately rectangular shape, a first seam allowance part of an approximately rectangular shape connected to one of widthwise edges of the ornamental part, and a second seam allowance part of an approximately rectangular shape connected to the other of the widthwise edges of the ornamental part,
wherein the small-width woven fabric is a fabric produced by integral weaving with a weaving machine,
wherein an end part of the first fabric is overlapped on and seamed to the first seam allowance part of the small-width woven fabric, and
wherein an end part of the second fabric is overlapped on and seamed to the second seam allowance part of the small-width woven fabric.

2. The cover material for a vehicle seat sheet as recited in claim 1, wherein the small-width woven fabric is a woven fabric other than a woven fabric produced by cutting into a small-width.

3. The cover material for a vehicle seat sheet as recited in claim 1, wherein a width of the small-width woven fabric is in a range of 15 mm to 100 mm.

4. The cover material for a vehicle seat sheet as recited in claim 1,
wherein a first folded back part which is an end portion of the first fabric folded back on a back side of the first fabric is overlapped on an upper surface of the first seam allowance part of the small-width woven fabric, and the first seam allowance part, the first folded back part, and the first fabric are overlapped in this order and seamed by a first sewing thread, so that the first sewing thread is visible from an outside on a surface of a side edge portion of the first fabric on the small-width woven fabric side, and
wherein a second folded back part which is an end portion of the second fabric folded back on a back side of the second fabric is overlapped on an upper surface of the second seam allowance part of the small-width woven fabric, and the second seam allowance part, the second folded back part, and the second fabric are overlapped in this order and seamed by a second sewing thread, so that the second sewing thread is visible from an outside on a surface of a side edge portion of the second fabric on the small-width woven fabric side.

5. The cover material for a vehicle seat sheet as recited in claim 1,
wherein a first folded back part which is an end portion of the first fabric folded back on a back side of the first fabric is overlapped on an upper surface of the first seam allowance part of the small-width woven fabric, and the first folded back part and the first seam allowance part are overlapped and seamed by a first sewing thread, and the first fabric is arranged on the seamed first folded back part, so that the first sewing thread is invisible from an outside on a surface of the first fabric, and
wherein a second folded back part which is an end portion of the second fabric folded back on a back side of the second fabric is overlapped on an upper surface of the second seam allowance part of the small-width woven fabric, and the second folded back part and the second seam allowance part are overlapped and seamed by a second sewing thread, and the second fabric is arranged on the seamed second folded back part, so that the second sewing thread is invisible from an outside on a surface of the second fabric.

6. The cover material for a vehicle seat sheet as recited in claim 1,
wherein the ornamental part of the small-width woven fabric includes one or a plurality of piping parts including a tubular part extending in a lengthwise direction of the ornamental part and a core part arranged at an inside of the tubular part.

7. The cover material for a vehicle seat sheet as recited in claim 6,
wherein the small-width woven fabric is an integrally woven fabric including a warp forming at least the first seam allowance part, the second seam allowance part, and the tubular part, a weft forming at least the first seam allowance part, the second seam allowance part and the tubular part, and an insertion thread forming the core part, and the warp, the weft, and the insertion thread are integrally woven by a weaving machine.

8. The cover material for a vehicle seat sheet as recited in claim 7,
wherein the insertion thread is configured by a thread of 84 decitex to 15,000 decitex.

9. The cover material for a vehicle seat sheet as recited in claim 7,
wherein the insertion thread is a polyester stretched multifilament thread.
